(19) United States
(12) Patent Application Publication
(10) Pub. No.: US 2017/0354484 A1
(43) Pub. Date: Dec. 14, 2017

(54) Narrow Diameter Dental Implant with Multi-Unit Abutment

(71) Applicant: Omid Allan, Castle Hill (AU)

(72) Inventor: Omid Allan, Castle Hill (AU)

(21) Appl. No.: 15/623,296

(22) Filed: Jun. 14, 2017

Related U.S. Application Data
(60) Provisional application No. 62/349,821, filed on Jun. 14, 2016.

(51) Int. Cl. A61C 8/00

(52) U.S. Cl. CPC A61C 8/0024; A61C 8/0056; A61C 8/006; A61C 8/0037

(57) ABSTRACT

A narrow diameter dental implant with multi-unit abutment is surgically inserted for osseointegration into the jawbone of a patient, in order to attach a crown or tooth prosthetic. The dental implant includes an implant shaft, a threading extrusion, and an attachment abutment. The implant shaft is inserted within the jawbone during osseointegration surgery. The threading extrusion is connected along the implant shaft in order to secure the dental implant within the jawbone. The attachment abutment is connected to the implant shaft, such that the attachment abutment extrudes out from the patient's gum. Therefore, the attachment abutment is accessible for the dentist to attach a crown or tooth prosthetic.

The current application claims a priority to the U.S. Provisional Patent application Ser. No. 62/349,821 filed on Jun. 14, 2016.

### FIELD OF THE INVENTION

The present invention relates generally to dental implants. More specifically, the present invention is a dental implant which allows screw retained dental prosthesis to be fixed onto the present invention.

### BACKGROUND OF THE INVENTION

In recent years, society has placed importance dental health, and as a result, there is a demand for advancements in the field of dentistry. As people age or due to medical complications, people may lose teeth or suffer from extensive decay where replacement prosthetics are necessary. Currently, dentures are a common replacement option for lost or decayed teeth, in order to provide the patient with an effective means to chew food. Dentures, however, may slip through any motion of the patient's mouth. Thus, the dentures need to be repositioned and/or adhered within the patient's mouth to in order to comfortably position and secure the dentures within the patient's mouth.

Therefore, an object of the present invention is to provide a unique narrow diameter dental implant that allows for a screw retained dental prosthesis to be fixed using a fixation screw. The present invention is surgically inserted into the jawbone of a patient. A crown or tooth prosthetic is then attached to an abutment of the present invention.

### BRIEF DESCRIPTION OF THE DRAWINGS

FIG. 1 is a perspective view of the present invention.

FIG. 2 is a lateral view of the present invention.

FIG. 3 is a top view of the present invention.

FIG. 4 is a bottom view of the present invention.

FIG. 5 is a lateral view for an alternate embodiment of the present invention, wherein the attachment abutment is oriented at an obtuse angle with the mounting core.

FIG. 6 is a lateral view for an alternate embodiment of the present invention, wherein the crown torque restraint is laterally positioned to the abutment attachment.

### DETAIL DESCRIPTIONS OF THE INVENTION

All illustrations of the drawings are for the purpose of describing selected versions of the present invention and are not intended to limit the scope of the present invention.

The present invention is a narrow diameter dental implant with multi-unit abutment. The present invention is surgically inserted for osseointegration into the jawbone of a patient in order to attach a crown or tooth prosthetic. The present invention is preferred to be solid titanium in order to provide a strong permanent support for the crown or tooth prosthetic within the mouth of the patient.

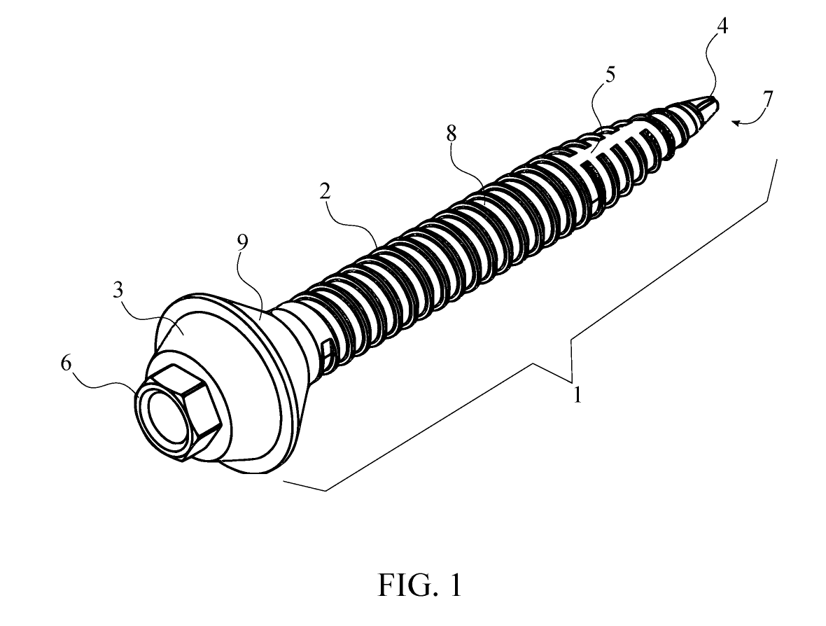

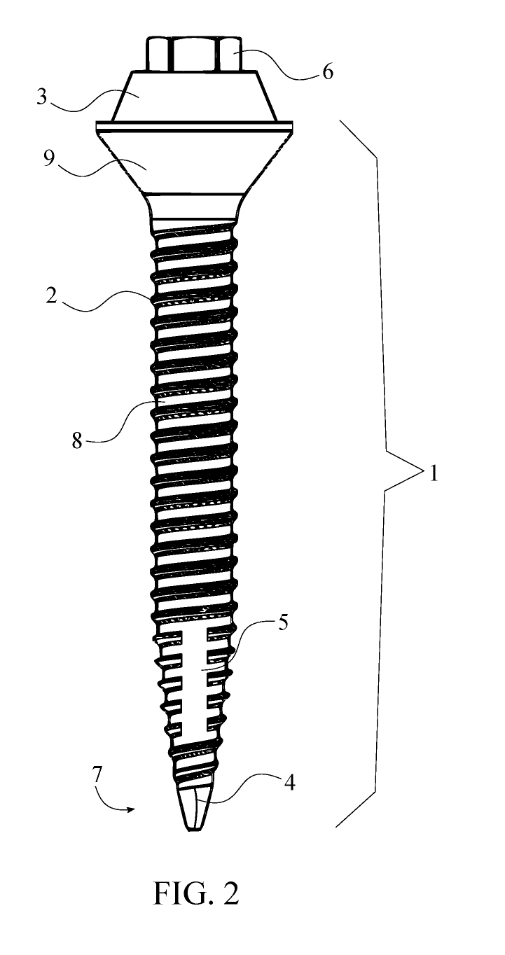

In accordance to FIG. 1 and FIG. 2, the present invention comprises an implant shaft 1, a threading extrusion 2, and an attachment abutment 3. The implant shaft 1 is a portion of the present invention that is inserted into the jawbone. The implant shaft 1 comprises an insertion end 7, a mounting core 8, and an abutment collar mounting end 9. The insertion end 7 is portion of the implant shaft 1 that first engages the jawbone when being surgically inserted into the jawbone. The insertion end 7 is adjacently connected to the mounting core 8. The mounting core 8 supports the threading extrusion 2. The abutment collar mounting end 9 is the portion of the implant shaft 1 that connects to the attachment abutment 3. The abutment collar mounting end 9 is adjacently connected to the mounting core 8. The insertion end 7 is oppositely positioned to the abutment collar mounting end 9 along the mounting core 8. The threading extrusion 2 secures the implant shaft 1 within the jawbone. The threading extrusion 2 is helically connected along the mounting core 8 in order to secure the present invention to the patient's jawbone. The attachment abutment 3 protrudes out from the gum of the patient in order for the crown or tooth prosthetic to be attached. The attachment abutment 3 is adjacently connected to the abutment collar mounting end 9 such that the attachment abutment 3 extrudes past the patient's gum to receive a crown or tooth prosthetic.

The present invention is preferred to be inserted into narrow jawbones that have a diameter of 3 millimeters (mm) or more. The implant shaft 1 has a diameter less than 3 mm to be inserted into these narrow jawbones. More specifically, the implant shaft 1 is preferred to be between 1.7 mm and 2.9 mm in order to be able to be inserted and secured within these narrow jawbones.

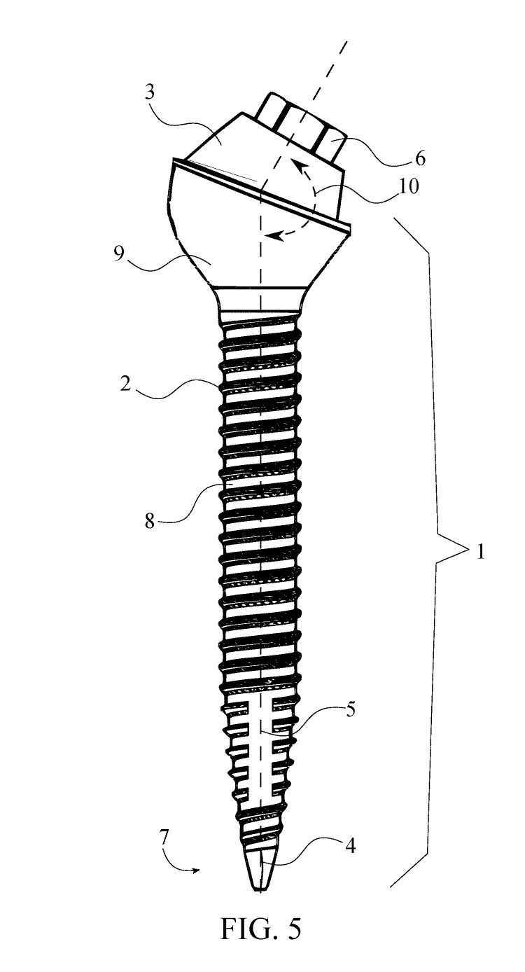

In accordance to some embodiments of the present invention, the attachment abutment 3 is oriented collinear to the mounting core 8, shown in FIG. 1 and FIG. 2. In some other embodiments of the present invention, the attachment abutment 3 is oriented at an obtuse angle 10 with the mounting core 8, wherein the obtuse angle 10 is preferred to be between 140° and 180° from the mounting core 8, shown in FIG. 5. The present invention is selected between these embodiments in accordance to the tooth being replaced and the best angle to affix the present invention with the jawbone.

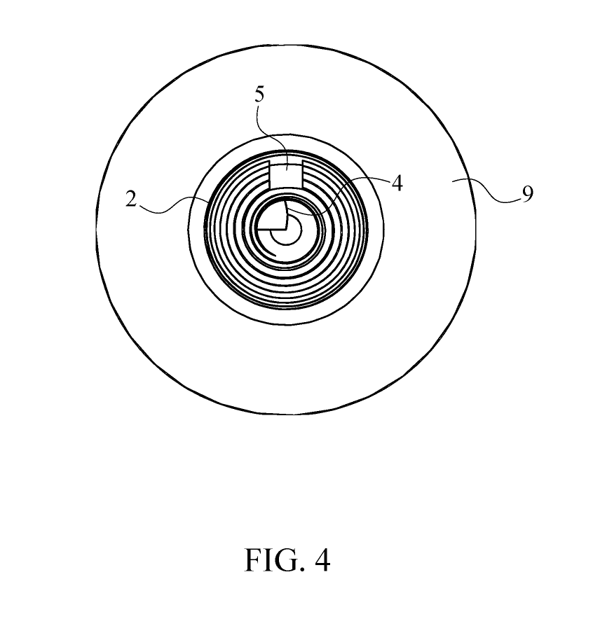

In accordance to the preferred embodiment of the present invention, the present invention comprises at least one self-tapping cutting edge 4, detailed in FIG. 1, FIG. 2, FIG. 4, and FIG. 5. The at least one self-tapping cutting edge 4 bores a pilot hole into the jawbone in order to displace bone matter for the implant shaft 1 to be positioned within the jawbone. The at least one self-tapping cutting edge 4 is integrated into the insertion end 7 to interface with the jawbone as the present invention is surgically inserted into the jawbone.

Further in accordance to the preferred embodiment of the present invention, the present invention comprises a debris extraction channel 5, shown in FIG. 1, FIG. 2, FIG. 4, and FIG. 5. The debris extraction channel 5 assists in removing bone debris from milling due to the threading extrusion 2 or the at least one self-tapping cutting edge 4 during the insertion of the present invention into the jawbone of the patient. The debris extraction channel 5 traverses laterally into the threading extrusion 2 and into the mounting core 8. The debris extraction channel 5 is adjacently positioned to the insertion end 7. The debris extraction channel 5 bone debris from the boring to be funneled out along the implant shaft 1 from the present invention being inserted into the jawbone.

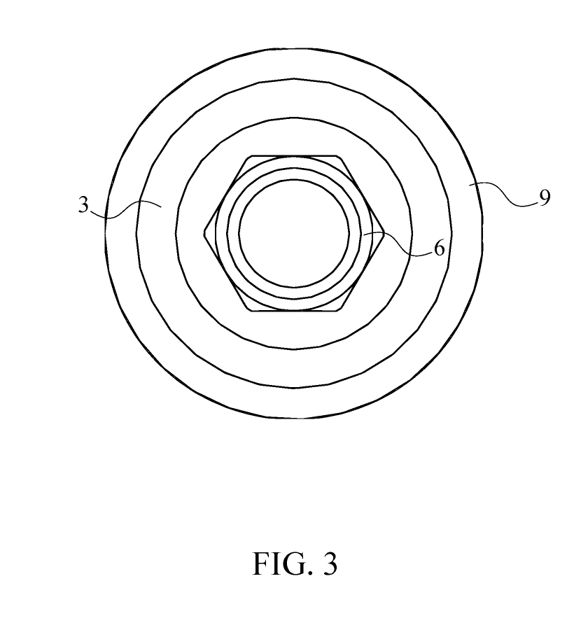

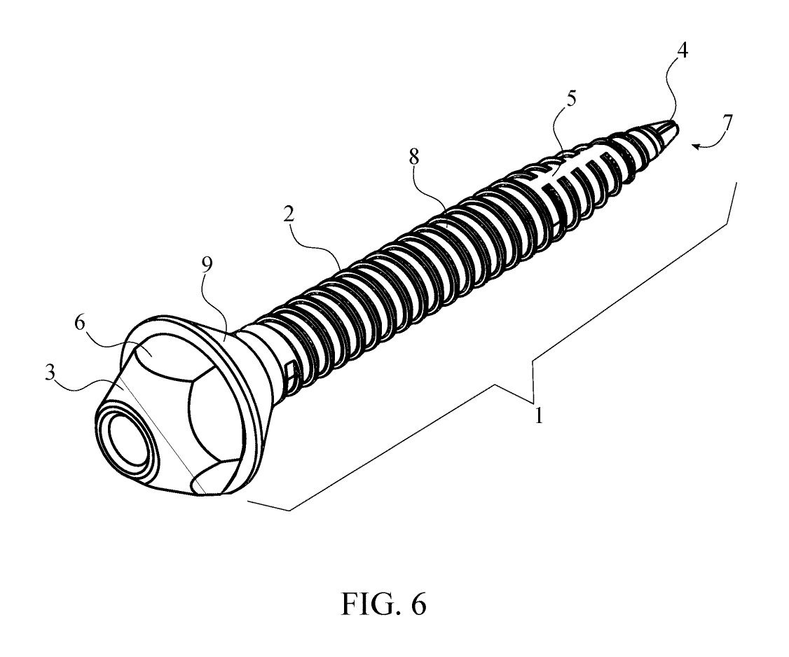

In some embodiments of the present invention, the present invention comprises a crown torque restraint 6, shown in FIG. 1 to FIG. 3 and FIG. 5. The crown torque restraint 6 is an extrusion on the attachment abutment 3 that prevents the crown or tooth prosthetic from rotating about the attachment abutment 3 and facilitates the insertion of the implant in the jawbone. The crown torque restraint 6 is adjacently connected to the attachment abutment 3. In a more specific embodiment of the present invention, the crown torque restraint 6 is oppositely positioned to the abutment collar mounting end 9 about the attachment abutment 3, shown in FIG. 1, FIG. 2 and FIG. 5. In another specific embodiment of the present invention, the crown torque restraint 6 is laterally positioned to the abutment attachment 3, shown in FIG. 6. In accordance to the preferred embodiment of the crown torque restraint 6, the crown torque restraint 6 is polygonal. The angular edges of the polygonal crown torque restraint 6 interface with the crown or tooth prosthetic to restrict the rotation of the crown or tooth prosthetic within the patient's mouth.

Although the invention has been explained in relation to its preferred embodiment, it is to be understood that many other possible modifications and variations can be made without departing from the spirit and scope of the invention as hereinafter claimed.

What is claimed is:

1. A narrow diameter dental implant with multi-unit abutment comprises:
an implant shaft;
a threading extrusion;
an attachment abutment;
the implant shaft comprises an insertion end, a mounting core, and an abutment collar mounting end;
the insertion end being adjacently connected to the mounting core;
the abutment collar mounting end being adjacently connected to the mounting core;
the insertion end being oppositely positioned to the abutment collar mounting end along the mounting core;
the threading extrusion being helically connected along the mounting core; and
the attachment abutment being adjacently connected to the abutment collar mounting end.

2. The narrow diameter dental implant with multi-unit abutment, as claimed in claim 1, comprises:
the attachment abutment being oriented collinear to the mounting core.

3. The narrow diameter dental implant with multi-unit abutment, as claimed in claim 1, comprises:
the attachment abutment being oriented at an obtuse angle with the mounting core.

4. The narrow diameter dental implant with multi-unit abutment, as claimed in claim 3, wherein the obtuse angle is between 140° and 180°.

5. The narrow diameter dental implant with multi-unit abutment, as claimed in claim 1, comprises:
at least one self-tapping cutting edge; and
the at least one self-tapping cutting edge being integrated into the insertion end.

6. The narrow diameter dental implant with multi-unit abutment, as claimed in claim 1, comprises:
a debris extraction channel;
the debris extraction channel laterally traversing through the threading extrusion and into the mounting core; and
the debris extraction channel being adjacently positioned to the insertion end.

7. The narrow diameter dental implant with multi-unit abutment, as claimed in claim 1, comprises:
a crown torque restraint;
the crown torque restraint being adjacently connected to the attachment abutment; and

8. The narrow diameter dental implant with multi-unit abutment, as claimed in claim 7, comprises:
the crown torque restraint being oppositely positioned to the abutment collar mounting end about the attachment abutment.

9. The narrow diameter dental implant with multi-unit abutment, as claimed in claim 7, comprises:
the crown torque restraint being laterally positioned to the abutment attachment.

10. The narrow diameter dental implant with multi-unit abutment, as claimed in claim 7, wherein the crown torque restraint is polygonal.

11. The narrow diameter dental implant with multi-unit abutment, as claimed in claim 1, wherein a diameter of the implant shaft is less than 3 millimeters (mm).

12. The narrow diameter dental implant with multi-unit abutment, as claimed in claim 11, wherein a diameter of the implant shaft is between 1.7 mm and 2.9 mm.
